(19) United States
(12) Patent Application Publication
(10) Pub. No.: US 2012/0269256 A1
(43) Pub. Date: Oct. 25, 2012

(54) APPARATUS AND METHOD FOR PRODUCING/REGENERATING CONTENTS INCLUDING MPEG-2 TRANSPORT STREAMS USING SCREEN DESCRIPTION

(76) Inventors: Myung Seok Ki, Daejeon (KR); Han Kyu Lee, Daejeon (KR); Jin Woo Hong, Daejeon (KR); Jihun Cha, Daejeon (KR); Hyun Cheol Kim, Daejeon (KR); Injae Lee, Daejeon (KR)

(21) Appl. No.: 13/518,598

(22) PCT Filed: Oct. 14, 2010
(86) PCT No.: PCT/KR10/07018

§ 371 Date: Jun. 22, 2012

(30) Foreign Application Priority Data
Dec. 22, 2009 (KR) 10-2009-0128603
Mar. 31, 2010 (KR) 10-2010-0029007

(51) Int. Cl. H04N 7/12

(52) U.S. Cl. 375/240.01; 375/E07.026

(57) ABSTRACT

Provided are a content writing apparatus and a content playback apparatus. The content writing apparatus may regard, as a single media file, a plurality of Moving Picture Experts Group (MPEG)-2 Transport Streams (TSs), may form a scene in a scene descriptor, such as a BInary Format for Scene (BIFS) or a Lightweight Application Scene Representation (LASeR), and may record the formed scene and the plurality of MPEG-2 TSs, as a media file in an International Standards Organization (ISO) format. The content playback apparatus may extract a scene from the media file in the ISO format, and may play back the extracted scene.

### TECHNICAL FIELD

The present invention relates to an apparatus and method for writing and playing back content that may use, as a single media file, a plurality of Moving Picture Experts Group (MPEG)-2 Transport Streams (TSs) and a scene that is formed using a scene descriptor, such as a BInary Format for Scene (BIFS) or a Lightweight Application Scene Representation (LASeR).

### BACKGROUND ART

As domestic digital broadcasting expands, a scheme of storing Moving Picture Experts Group (MPEG)-2 Transport Streams (TSs) without any change is increasingly used together with a scheme of recording a broadcast program in different types for each existing terminal company.

To realize compatibility with an existing broadcast terminal, an Internet Protocol Television (IPTV) may use a scheme of packaging an existing broadcast program into an IP packet, transmitting the IP packet, and displaying the IP packet on the terminal, rather than processing MPEG-2 TSs. Additionally, in an MPEG, a scheme of recording and playing back MPEG-2 TSs in a file format without processing the MPEG-2 TSs also has been discussed. Accordingly, there is a standardized scheme that enables the MPEG-2 TSs to be included in an International Standards Organization (ISO)-based media file as a file standard.

A scheme of distributing, as a single content, MPEG-2 TSs that were used as transmission means in a market is being widespread. However, there was no scheme yet to accept MPEG-2 TSs in a scene descriptor, such as BInary Format for Scene (BIFS) or a Lightweight Application Scene Representation (LASeR).

In other words, to transmit a content written using the scene descriptor to a broadcast network, a scheme of forming AV contents using the scene descriptor, multiplexing the AV contents using a MPEG-2 multiplexing system, and generating MPEG-2 TSs is currently being used in the same manner as a terrestrial Digital Multimedia Broadcasting (DMB).

However, the above scheme may cause a problem in that MPEG-2 demultiplexers in terminals need to be modified when an MPEG-2 demultiplexer in an existing commercial terminal is unable to interpret the scene descriptor. Additionally, it is difficult for an existing terminal to accept MPEG-2 TSs, when each of the MPEG-2 TSs includes a scene descriptor and a plurality of AV contents, instead of a single AV content.

As described above, a scheme of writing a scene using a scene descriptor, multiplexing the scene, and generating MPEG-2 TSs may require modification of MPEG-2 demultiplexers of existing commercial terminals. Accordingly, when the scheme is performed without processing MPEG-2 TSs, it is possible to have an advantage of compatibility with existing broadcast terminals.

However, since MPEG-2 TSs have different stream structures in a terrestrial Digital TV (DTV) and a satellite/terrestrial DMB, MPEG-2 TSs are not compatible with each other. Additionally, since a structure of an MPEG-2 TS is not for storage, MPEG-2 TSs are insufficient for use in distribution or local playback.

To solve the problems, in the MPEG, a scheme of storing MPEG-2 TSs in a media file in an ISO format may be standardized, so that the MPEG-2 TSs may be operated. However, since only the scheme of storing MPEG-2 TSs in an ISO-based media file is standardized, it is difficult to apply the ISO file format to a scheme of forming contents using MPEG-2 TSs as media in a scene descriptor.

### DISCLOSURE OF INVENTION

### Technical Goals

An aspect of the present invention provides an apparatus and method for writing and playing back content that may regard both of a scene formed using a scene descriptor and a plurality of MPEG-2 TSs, as a single media file such as video or audio, and may easily play back the media file based on original MPEG-2 TSs, so that an interactive function may be performed.

### Technical solutions

According to an aspect of the present invention, there is provided an apparatus for writing content, the apparatus including: a media input unit to receive an input of a plurality of Moving Picture Experts Group (MPEG)-2 Transport Streams (TSs); a scene writing unit to form a scene using a scene descriptor, the scene being associated with the plurality of MPEG-2 TSs; and a file encoder to encode the plurality of MPEG-2 TSs and the formed scene into a single media file, the single media file including a Movie Box (moov) including structure information, and a Movie Data Box (mdat) including actual contents rendered at a corresponding time based on the formed scene.

The mdat may include a main scene descriptor to store the formed scene as structure information used to control the plurality of MPEG-2 TSs.

The moov may include a scene descriptor track and an Object Descriptor (OD) track to determine whether the plurality of MPEG-2 TSs are connected to each other in the media file, the scene descriptor track and the OD track being a part of the formed scene, and an Initial Object Descriptor (IOD) to acquire an Elementary Stream Identifier (ES_ID) of the scene descriptor track, and an ES_ID of the OD track.

The scene writing unit may form the scene including a scene structure and a user event that are associated with the plurality of MPEG-2 TSs.

The apparatus may further include an MPEG-2 TS interpreter to interpret the plurality of MPEG-2 TSs, and to extract the scene descriptor. Here, the scene writing unit may form the scene using a scheme of forming multiple scenes by the extracted scene descriptor.

According to another aspect of the present invention, there is provided an apparatus for playing back content, the apparatus including: a file interpreter to load a media file from a storage device, to divide the loaded media file into a scene and a plurality of MPEG-2 TSs, and to interpret a structure of a moov and a structure of a mdat from the media file, the moov including media information including at least one of decoding information of Audio/Video (AV) media, random time access information, and synchronization information between different media, and structure information used to control the plurality of MPEG-2 TSs, and the mdat including actual contents rendered at a corresponding time based on the scene; an MPEG-2 TS interpreter to interpret the plurality of MPEG-2 TSs and to extract a Packetized Elementary Stream (PES) packet; a PES packet interpreter to extract AV media corresponding to a media type from the extracted PES packet; an AV decoder to decode the extracted AV media; and an AV output unit to output the decoded AV media.

The apparatus may further include a scene interpreter to interpret a scene structure, a user event, and a rendering time from a scene, the scene being received from the file interpreter; and a scene renderer to render objects based on at least one of the interpreted scene structure, the interpreted user event, and the interpreted rendering time. Here, the filter interpreter may transfer the scene to the scene interpreter when the media file contains the scene.

The scene interpreter may interpret a scene descriptor for rendering a sub-scene when the scene descriptor exists in the MPEG-2 TSs.

According to another aspect of the present invention, there is provided a method of writing content, the method including: receiving an input of a plurality of MPEG-2 TSs; forming a scene using a scene descriptor, the scene being associated with the plurality of MPEG-2 TSs; and encoding the plurality of MPEG-2 TSs and the formed scene into a single media file, the single media file including a moov including structure information, and an mdat including actual contents rendered at a corresponding time based on the formed scene.

According to another aspect of the present invention, there is provided a method of playing back content, the method including: dividing a loaded media file into a scene and a plurality of MPEG-2 TSs; interpreting a structure of a moov and a structure of an mdat from the media file, the moov including media information including at least one of decoding information of AV media, random time access information, and synchronization information between different media, and structure information used to control the plurality of MPEG-2 TSs, and the mdat including actual contents rendered at a corresponding time based on the scene; interpreting the plurality of MPEG-2 TSs and extracting a PES packet; extracting AV media corresponding to a media type from the extracted PES packet; decoding the extracted AV media; and outputting the decoded AV media.

### Effect

According to embodiments of the present invention, when a scene associated with Moving Picture Experts Group (MPEG)-2 Transport Streams (TSs) is formed, the formed scene may be regarded as a single media file, and may be contained in an International Standards Organization (ISO)-based media file, so that it is possible to create an environment where the scene is able to be transmitted to a terminal device in a receiving end, for example a content playback apparatus, without any problem in compatibility.

Additionally, according to embodiments of the present invention, a terminal device that already includes an MPEG-2 demultiplexer may process several scene languages by only adding a scene descriptor processing module to a preprocessing module, rather than modifying an MPEG-2 demultiplexer of an existing terminal device, so that it may be easy to apply a scene descriptor to an actual commercial model.

Furthermore, according to embodiments of the present invention, when an ISO-based media file including a plurality of MPEG-2 TSs is formed, the plurality of MPEG-2 TSs may be operated as a single file without a metadata decoder, and stored MPEG-2 TSs may be reprocessed to generate a file that enables various additional functions to be provided.

For example, to broadcast a stereoscopic image, only a single TS may be transmitted, since it is impossible for a current DMB to provide the stereoscopic image due to a problem of a bandwidth. Additionally, when left and right TSs are formed in the form of pay contents using a scene descriptor, distinctive contents may be generated.

### BRIEF DESCRIPTION OF DRAWINGS

FIG. 1 is a block diagram illustrating a content writing apparatus according to an embodiment of the present invention;

FIG. 2 is a block diagram illustrating a content playback apparatus according to an embodiment of the present invention;

FIG. 3 is a diagram illustrating a structure of a general MPEG layer 4 (MP4) file including a scene descriptor and Audio/Video (AV) contents;

FIG. 4 is a diagram illustrating an example of a scheme of forming multiple scenes using a BInary Format for Scene (BIFS);

FIG. 5 is a diagram illustrating an example of a Decoder_Specific_Info defined to decode Moving Picture Experts Group (MPEG)-2 Transport Streams (TSs);

FIG. 6 is a diagram illustrating an example of a structure of a Lightweight Application Scene Representation (LASeR) Simple Aggregation Format (SAF) packet of a file where objects of a scene are formed by Access Units (AUs) and packaged;

FIG. 7 is a diagram illustrating an example of a structure of an International Standards Organization (ISO)-based media file according to an embodiment of the present invention;

FIG. 8 is a flowchart illustrating a method of writing content including a media file according to an embodiment of the present invention; and

FIG. 9 is a flowchart illustrating a method of playing back content including a media file according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

Technical goals of the present invention may be to use Moving Picture Experts Group (MPEG)-2 Transport Streams (TSs) as input media in a scene descriptor without any change in scene description configuration.

Additionally, according to an aspect of the present invention, a terminal device that already includes an MPEG-2 demultiplexer may process several scene languages by only adding a scene descriptor processing module to a preprocessing module, rather than modifying an MPEG-2 demultiplexer of an existing terminal device, so that it may be easy to apply a scene descriptor to an actual commercial model.

To achieve the aspect, a general structure of writing and playing back a content including MPEG-2 TSs according to the present invention may be provided as below.

The present invention may provide a content writing apparatus to write a scene using a plurality of MPEG-2 TSs as input media so that the written scene may be contained in a single media file, and a content playback apparatus to interpret the scene and the plurality of MPEG-2 TSs from the media file and to output the interpreted scene and the MPEG-2 TSs.

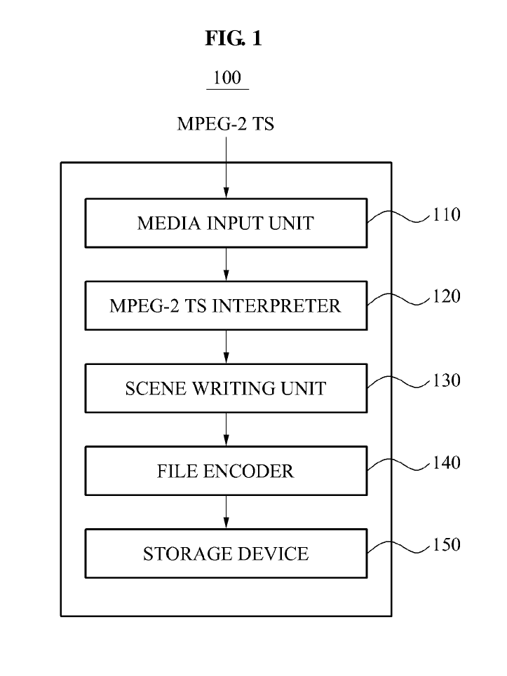

FIG. 1 is a block diagram illustrating a content writing apparatus 100 according to an embodiment of the present invention.

Referring to FIG. 1, the content writing apparatus 100 may include a media input unit 110, an MPEG-2 TS interpreter 120, a scene writing unit 130, and a file encoder 140. A storage device 150 may be included in the content writing apparatus 100 as shown in FIG. 1, or may be provided separately from the content writing apparatus 100 according to another embodiment.

The content writing apparatus 100 of FIG. 1 may form a scene using a scene descriptor, and may arrange the formed scene in a media file.

The media input unit 110 may receive one MPEG-2 TS or a plurality of MPEG-2 TSs that are input on a screen for a writing operation. In other words, the media input unit 110 may receive an input of one MPEG-2 TS or a plurality of MPEG-2 TSs. Here, the MPEG-2 TSs may include a scene descriptor.

The MPEG-2 TS interpreter 120 may extract a structure and information regarding the input MPEG-2 TSs. Specifically, the MPEG-2 TS interpreter 120 may interpret the MPEG-2 TSs, and may extract at least one of a Program Map Table (PMT), the scene descriptor, and access information.

The scene writing unit 130 may write a scene including a scene arrangement and a user event, using the input MPEG-2 TSs and other media, and may store the written scene in a text form or other interpretable forms. Specifically, the scene writing unit 130 may control the input MPEG-2 TS or the plurality of input MPEG-2 TSs, and may form content information using the scene descriptor to form a scene for an interactive service function.

For example, when the scene descriptor is not contained in the input MPEG-2 TSs, the scene writing unit 130 may form a main scene for controlling the MPEG-2 TSs as the scene using a single scene formation technique.

Conversely, when the scene descriptor is contained in the input MPEG-2 TSs, the scene writing unit 130 may form a main scene for controlling the MPEG-2 TSs as a scene using a multi-scene formation technique.

The file encoder 140 may convert the written scene and the MPEG-2 TSs as media into a single media file that is available in playback and distribution. Specifically, the file encoder 140 may encode the plurality of MPEG-2 TSs and the formed scene into a single media file that includes a Movie Box (moov) and a Movie Data Box (mdat). Here, the moov may include structure information, and the mdat may include actual contents rendered at a corresponding time based on the formed scene.

Additionally, the media file may be an International Standards Organization (ISO)-based media file. In other words, the file encoder 140 may encode the formed scene in a binary form, so that the encoded scene may be included in an ISO file that is to be generated.

The storage device 150 may store the scene and the MPEG-2 TSs in a media file that is in an ISO format. The content writing apparatus 100 may further include an ISO file encoder (not shown) to encode the input MPEG-2 TSs and the formed scene into a single ISO-based media file. Here, the storage device 150 may store the encoded ISO-based media file.

There is no need to convert results written by the content writing apparatus 100 into a file format, and a file converting operation of the content writing apparatus 100 is merely an example for convenience of description of the present invention.

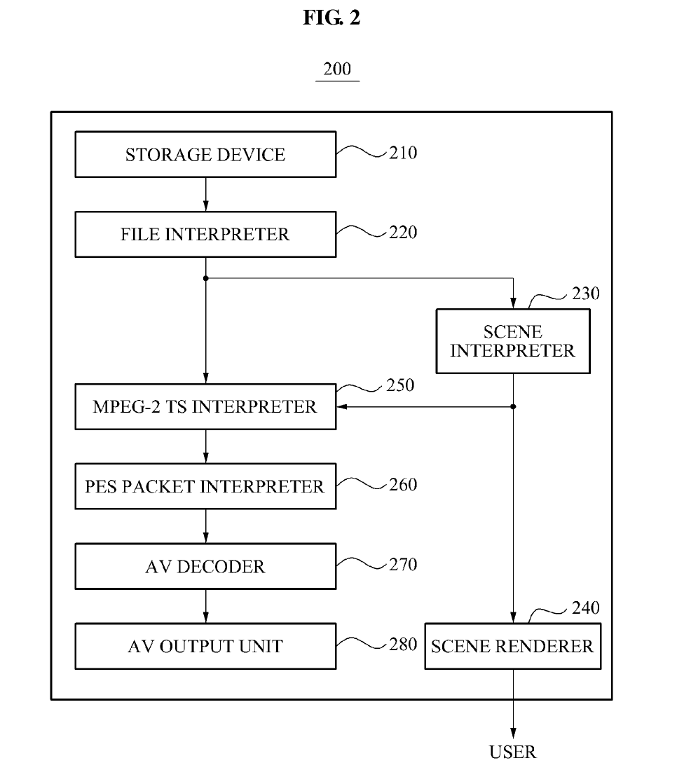

FIG. 2 is a block diagram illustrating a content playback apparatus 200 according to an embodiment of the present invention.

Referring to FIG. 2, the content playback apparatus 200 may include a storage device 210, a file interpreter 220, a scene interpreter 230, a scene renderer 240, an MPEG-2 TS interpreter 250, a Packetized Elementary Stream (PES) packet interpreter 260, an Audio/Video (AV) decoder 270, and an AV output unit 280.

The content playback apparatus 200 may load, from the storage device 210, results written in a media file format or other formats. The storage device 210 may be implemented as the storage device 150 included in the content writing apparatus 100, and may store, in the media file format, a result written by forming scenes.

The file interpreter 220 may load a media file a user desires to play back from the storage device 210, may divide the loaded media file into a scene and a plurality of MPEG-2 TSs, and may interpret a structure of a moov and a structure of an mdat from the media file. Here, the moov may include media information including at least one of decoding information of AV media, random time access information, and synchronization information between different media, and structure information that is used to control the plurality of MPEG-2 TSs. The mdat may include actual contents rendered at a corresponding time based on the scene into which the loaded media file is divided. In other words, the file interpreter 220 may prepare operations for playback of the media file.

For example, when a written result is stored as a single media file, and when there is no scene formed using a scene descriptor in the media file, the file interpreter 220 may control the MPEG-2 TS interpreter 250 so that the media file may be divided into media and a scene by interpreting a structure of the media file to be interpreted for playback.

Conversely, when a scene descriptor used to control a scene is contained in a loaded media file, the file interpreter 220 may transmit the loaded media file to the scene interpreter 230. In other words, when a scene formed using a scene descriptor exists in the media file, the file interpreter 220 may transfer the loaded result to the scene interpreter 230, and the scene interpreter 230 may interpret a configuration of the entire scene and a user event.

The scene interpreter 230 may recognize a scene to interpret a scene configuration for rendering the scene on the media file.

When the scene interpreter 230 completes interpretation of the scene configuration, the scene renderer 240 may render an interpreted scene and objects on a display or an external output device. Here, the objects may be output at each corresponding time.

Conversely, when the interpretation is not completed since an MPEG-2 TS exists in the scene, the MPEG-2 TS interpreter 250 may interpret the MPEG-2 TS, and may transmit each PES packet corresponding to each PID packet identifier to the PES packet interpreter 260.

The PES packet interpreter 260 may interpret the received PES packet, may extract media corresponding to each media type from the extracted PES packet, and may transmit the extracted media to the AV decoder 270.

The AV decoder 270 may decode AV media, and may transmit decoded media data to the AV output unit 280. Specifically, the AV decoder 270 may decode the divided AV data, so that the decoded AV data may be played back by the AV output unit 280 based on the interpreted scene.

The AV output unit 280 may output the decoded AV media by synchronizing the decoded AV media based on each time for rendering performed by the scene renderer 240 or a user event manipulation.

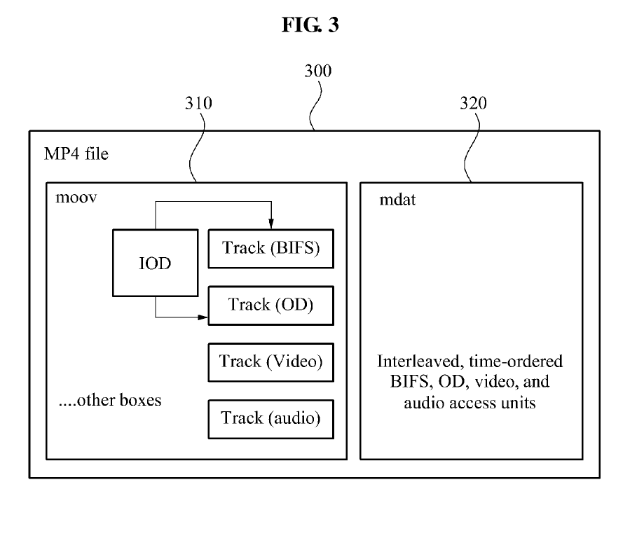

FIG. 3 is a diagram illustrating a structure of a general MPEG layer 4 (MP4) file 300 including a scene descriptor and AV contents.

Referring to FIG. 3, the MP4 file 300 is a kind of an ISO-based media file, and has a structure used to form a Digital Multimedia Broadcasting Application Format (DMB-AF) file. Similarly to the DMB-AF file, the MP4 file 300 may include a moov 310 where media formats are described, and an mdat 320 that includes actual data. Access information and interpretation information of media may be contained in a track box and other sub-boxes in the moov 310. Actual contents may be contained in the mdat 320, and may be rendered at a corresponding time based on an interpreted scene.

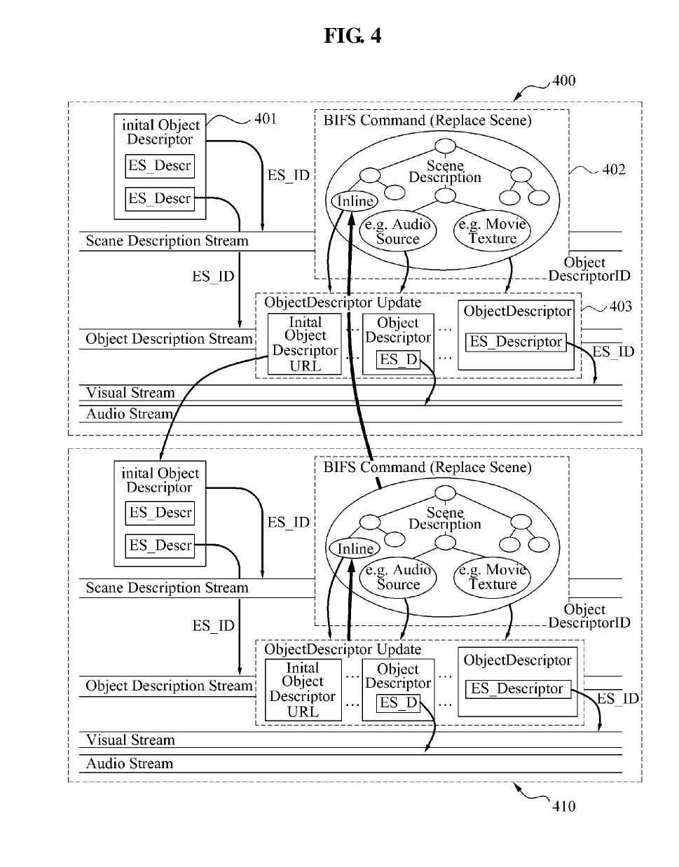

FIG. 4 is a diagram illustrating an example of a scheme of forming multiple scenes using a BInary Format for Scene (BIFS).

Referring to FIG. 4, a content 400 includes an Initial Object Descriptor (IOD) 401, a BIFS 402 that is used as a scene descriptor, an Object Descriptor (OD) 403, and AV media. To interpret a scene of a scene descriptor, interpretation of the IOD 401 may be performed first. The IOD 401 includes an Elementary Stream Identifier (ES_ID) of the BIFS 402, and an ES_ID of the OD 403 in the scene. When a main scene has a plurality of sub-scenes, another content 410 may be designated as a sub-scene in information written by the BIFS 402, through a scheme such as an inline scheme. Accordingly, while a predetermined scene of a content is rendered, a scene of another content may also be rendered as a sub-scene of the predetermined scene of the content.

Generally, writing information of scene formation, and media used to form a scene may be obtained as results written using a scene descriptor. Link information of actual media may be described in scene writing information.

The IOD 401 may be defined as information interpreted when an initial user receives a scene from an MPEG-4 system. The ES_ID of the BIFS 402 and the ES_ID of the OD 403 may be described in the IOD 401. Here, the ES_ID of the BIFS 402 may be defined as initialization information and scene information that are used to form a scene, and the ES_ID of the OD 403 may be defined as information on an object to be rendered on a scene.

An MPEG-4 system decoder may acquire the ES_ID of the BIFS 402 and the ES_ID of the OD 403 by interpreting an ES_ID of the IOD 401. The MPEG-4 system decoder may interpret a scene description stream based on the acquired ES_IDs, and may acquire scene formation information. Additionally, the MPEG-4 system decoder may acquire information regarding a media object in a scene through a connected object description stream.

Each ES_Descriptor of the IOD 401 may include an ES_ID and decoding information of a media object. The MPEG-4 system decoder may connect actual media to a media decoder based on the ES_Descriptor, and may render decoded media on a scene.

A basic concept of a scene descriptor is similar to that of an MPEG-4 system. In the MPEG-4 system, AV media may be connected as individual objects to existing scene descriptors, and a separate system provided by the scene descriptors may be synchronized. However, the scene descriptor of the present invention may connect MPEG-2 TSs regarded as a single media file, and may function to only process the start, the stop and the random time access with respect to the MPEG-2 TSs, and an MPEG-2 demultiplexer may synchronize media in the MPEG-2 TSs.

As described above, since there is no scheme of processing MPEG-2 TSs in a media format in existing scene descriptors, several changes may be required to accept the MPEG-2 TSs.

First, an MIME Type needs to be defined to accept MPEG-2 TSs in a scene descriptor.

The MIME Type is referred to as an ID of described data. A system may determine, based on the MIME Type, a type of a described object, for example a video object, or an audio object, or other objects.

Additionally, decoding information for media interpretation may need to be added to the scene descriptor, to interpret new media. For example, in an MPEG-4 system, a field related to an OD needs to be modified, in other words, a new declaration needs to be added to a streamtype and an objectTypeIndication of a DecoderConfigDescriptor in the OD, in order to accept MPEG-2 TSs.

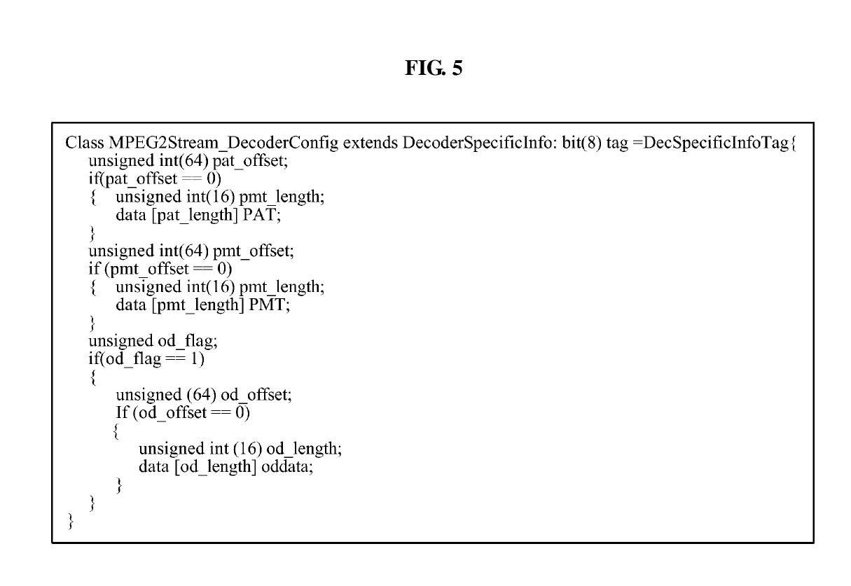

FIG. 5 is a diagram illustrating an example of a Decoder_Specific_Info defined to decode MPEG-2 TSs.

Referring to FIG. 5, to form an interactive content based on MPEG-2 TSs regarded as media in an MPEG scene descriptor, a field related to an “OD” of an existing MPEG-4 system needs to be modified, and in particular, a declaration needs to be performed in the objectTypeIndication and the streamtype of the DecoderConfigDescriptor of the OD, so that MPEG-2 TSs may be accepted. Additionally, to decode MPEG-2 TSs, the DecoderSpecifcInfo may be described. The DecoderSpecifcInfo for MPEG TSs is shown in FIG. 5.

To store, in an ISO-based file, a scene formed by a scene descriptor, such as a BIFS or a Lightweight Application Scene Representation (LASeR), and general MPEG-2 TSs where there is no scene descriptor, and to control the ISO-based file using the BIFS, an ISO-based media file may be generated by changing only a partial item of an OD, regardless of a number of MPEG-2 TSs in the media file, in a same manner as a scheme of forming a content using the scene descriptor in an existing MP4 file format.

However, since an MPEG-2 TS already includes an IOD, a scene descriptor (BIFS), and an OD, a main scene descriptor and a main OD may collide with the scene descriptor and the OD included in the MPEG-2 TS when a scene is formed using a scene descriptor by a general scheme.

To solve the above problem, a scene may be formed using a multi-scene formation scheme that is used in an MPEG BIFS and a LASeR.

An MPEG-2 Sample Entry box defined in an ISO-based media file may be referred to for compatibility with an ISO-File Format (FF) of an existing MPEG standard. A data syntax may have different box information to be added, based on characteristics of an MPEG-2 TS. A PAT of an actual MPEG-2 TS and Program Map Table (PMT) data may need to be basically added. When additional data is required to access MPEG-2 TSs, new data may be added.

For example, when an MPEG-2 TS is a terrestrial DMB stream, an OD and a scene descriptor in addition to a PAT and a PMT may need to be interpreted to randomly access and play back the MPEG-2 TS. In this example, the OD and the scene descriptor may be defined as additional data.

As another embodiment, an MPEG-2 TS may be used in an MPEG LASeR as below.

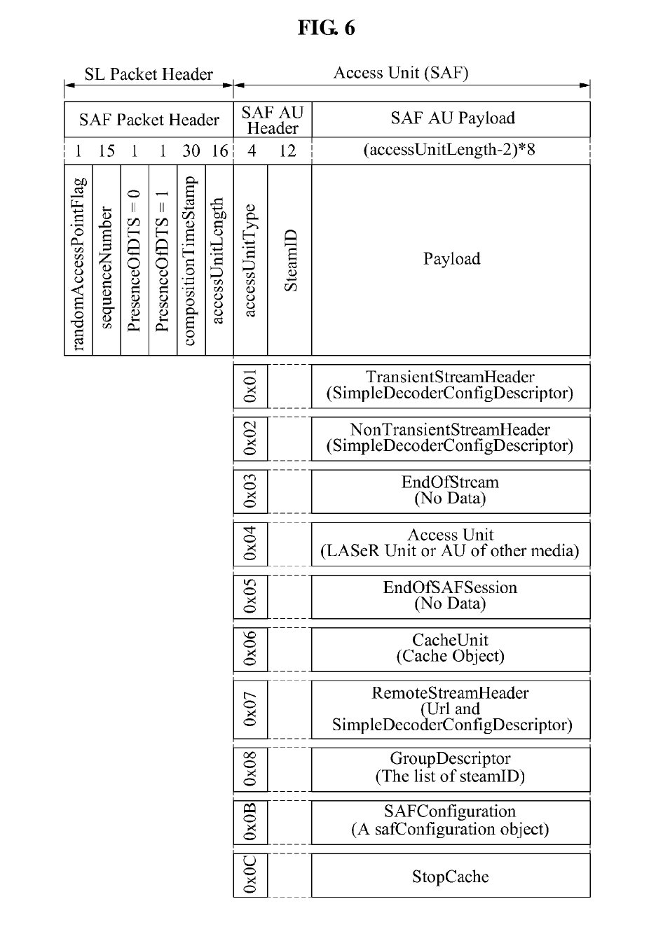

In the LASeR, a media file format, such as a Simple Aggregation Format (SAF) or an ISO format, may be used to perform AV synchronization playback. The SAF may be a format of a file where objects of a scene are formed by Access Units (AUs) and packaged in a LASeR language. A packet structure of the SAF is shown in FIG. 6.

FIG. 6 is a diagram illustrating an example of a structure of a Lightweight Application Scene Representation (LASeR) Simple Aggregation Format (SAF) packet of a file where objects of a scene are formed by Access Units (AUs) and packaged.

To apply an MPEG-2 TS in the LASeR in the same manner as the MPEG-4 system, information used to interpret the MPEG-2 TS may be added to an SAF packet header. Accordingly, in the present invention, SAF packet header information may be described using synchronization information in existing MPEG-2 TSs.

A randomaccessPointFlag value of FIG. 6 may be described by extracting a random access Indicator flag in an adaptation field of an MPEG-2 TS header. A sequenceNumber may be described using an existing scheme of forming an SAF packet header, and a compositionTimeStamp may be described using a CTS value of a PES packet header. However, interpretation from the SAF packet to the PES packet may be required and thus, the sequenceNumber and the compositionTimeStamp may be described using a Program Clock Reference (PCR) value.

Additionally, an accessUnitLength may be described by processing, as a single AU, from a video PES packet or an audio PES packet of an MPEG-2 TS, to a packet of the same type as the previous packet. Here, in the two packets, a payload unit start indicator may be set to “1”. Alternatively, the accessUnitLength may be described by processing a single packet of the MPEG-2 TS as a single AU.

A scene formed using a scene descriptor may include at least one AV media. For example, an MPEG-4 BIFS and a LASeR may permit formation of a single scene using several AV media. When an MPEG-2 TS is regarded as media and is permitted in a scene descriptor, the MPEG-2 TS may be processed in a same manner as general media even though the MPEG-2 TS has a general structure and though a plurality of AV media are input.

However, when a scene descriptor is already included in the MPEG-2 TS, for example a terrestrial DMB, during processing of an MPEG-2 TS regarded as media in a scene descriptor, that is, when a scene descriptor for forming a scene is identical to the scene descriptor in the MPEG-2 TS, the two scene descriptors may collide with each other.

In the present invention, when the MPEG-2 TS already includes a scene descriptor, a multi-scene formation scheme may be used to prevent colliding with an upper scene descriptor.

As another embodiment of the present invention, a formation of multiple scenes including several scene descriptors may be described.

A content using MPEG-4 Systems may include an IOD, a scene descriptor (BIFS), an OD, and AV media.

To interpret a scene of a scene descriptor, interpretation of the IOD may be performed first. The IOD includes an ES_ID of the scene descriptor, and an ES_ID of the OD in the scene. When a main scene has a plurality of sub-scenes, another content may be designated as a sub-scene in information written by the scene descriptor, through an inline scheme or other schemes. Here, an MPEG-4 system decoder may render a main scene, while rendering another designated scene as a sub-scene in the main scene.

Generally, a content written using a scene descriptor is packaged in a single file form to be managed, distributed and played back, because use of the packaged file may provide great advantages in content interpretation, and in access and playback at a random time, compared with independently operating a scene descriptor and an MPEG-2 TS using only link information.

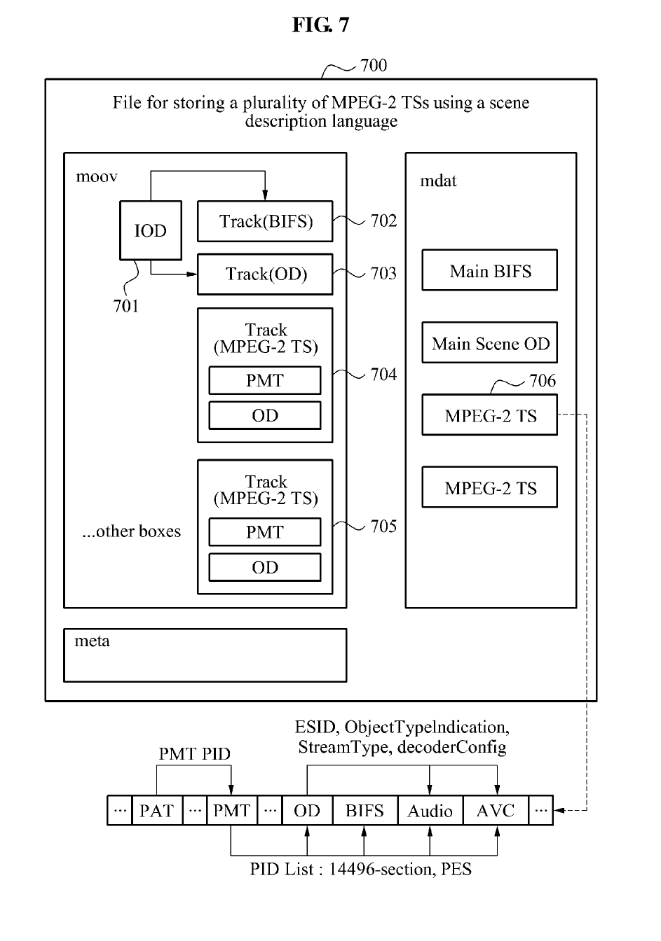

FIG. 7 is a diagram illustrating an example of a structure of an ISO-based media file 700 according to an embodiment of the present invention.

As shown in FIG. 7, the ISO-based media file 700 may be formed of an MPEG-2 TS such as a terrestrial DMB TS that already includes a scene descriptor, when a scene is written using the scene descriptor. Here, the MPEG-2 TS may be regarded as media.

A structure of an MPEG-2 TS 706 of FIG. 7 is merely an example of a terrestrial DMB stream. When another scene descriptor, for example a LASeR, is used, the structure of the MPEG-2 TS 706 may be changed, however, basic operations of the MPEG-2 TS 706 may remain unchanged.

An ISO-based file may include a moov including media information and structure information used to control the MPEG-2 TSs, and an mdat including actual contents. The moov may include at least one of decoding information of AV media, random time access information, and synchronization information between different media. The actual contents in the mdat may be rendered at a corresponding time based on the interpreted scene information.

When writing a file, a user may form a main scene descriptor with one MPEG-2 TS or a plurality of MPEG-2 TSs that are acquired in advance, using a scene writing instrument, and may encode the main scene descriptor into a single file 700. Here, the main scene descriptor may be used to control two scenes, may have a structure for controlling DMB TSs, and may include written scenes.

To play back the file 700, a file interpreter may decode a structure of the moov of the file 700, and may recognize a structure of the file 700. Subsequently, a receiving device may interpret an IOD 701 of the file 700, and may acquire an ES_ID of a main scene descriptor track 702 and an ES_ID of a main OD track 703. The receiving device may acquire, based on the ES_IDs, information regarding the main scene descriptor track 702 and the main OD track 703, and may determine that MPEG-2 TSs of the file 700 may be connected to a part of a main scene through interpretation of the main scene descriptor track 702 and the main OD track 703.

A playback order and start of a plurality of DMB TSs may be set based on an operation of a main scene. When a DMB TS is selected by a user event on a scene rendered on a screen, the following operation may be performed.

The selected TS may include sub-scenes of the main scene. To rapidly interpret the DMB TS, a DMB AF file may enable a PMT and an OD of the TS to be included directly in a Track header, or enable a location of the TS to be referred to. Accordingly, when the sub-scenes are played back in the main scene descriptor, a receiving device may access an actual DMB TS 706 through interpretation of an IOD and OD of an MPEG-2 TS track box 704, and may perform decoding of a BIFS and AV of the DMB TS and rendering to sub-scenes of the main scene descriptor. The operation may equally be applied to an example where the file 700 includes a plurality of DMB TSs 705.

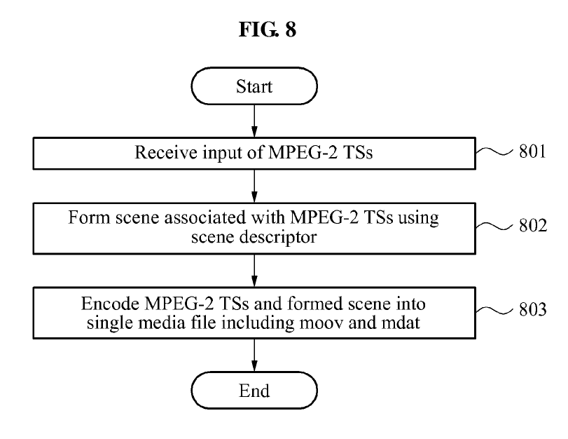

FIG. 8 is a flowchart illustrating a method of writing content including a media file according to an embodiment of the present invention.

Referring to FIG. 8, in operation 801, an input of a plurality of MPEG-2 TSs may be received.

In operation 802, a scene associated with the plurality of MPEG-2 TSs may be formed using a scene descriptor. Here, the scene may include a scene structure and a user event that are associated with the plurality of MPEG-2 TSs. Alternatively, the scene may be formed using a multi-scene formation scheme of interpreting the input MPEG-2 TSs, extracting the scene descriptor, and forming multiple scenes by the extracted scene descriptor.

In operation 803, the plurality of MPEG-2 TSs and the formed scene may be encoded into a single media file including a moov and an mdat. The moov may include media information including at least one of decoding information of AV media, random time access information, and synchronization information between different media, and structure information used to control the plurality of MPEG-2 TSs. Additionally, the mdat may include actual contents rendered at a corresponding time based on the scene.

Specifically, the media file may be encoded to the mdat including a main scene descriptor that is configured to control the MPEG-2 TSs and stores the formed scene.

Additionally, the media file may be encoded to the moov that includes a scene descriptor track, an OD track, and an IOD. The scene descriptor track and the OD track may be a part of the formed scene and may be used to determine whether the plurality of MPEG-2 TSs are connected to each other in a media file in an ISO file format through the interpretation. The IOD may be used to acquire an ES_ID of the scene descriptor track, and an ES_ID of the OD track through the interpretation.

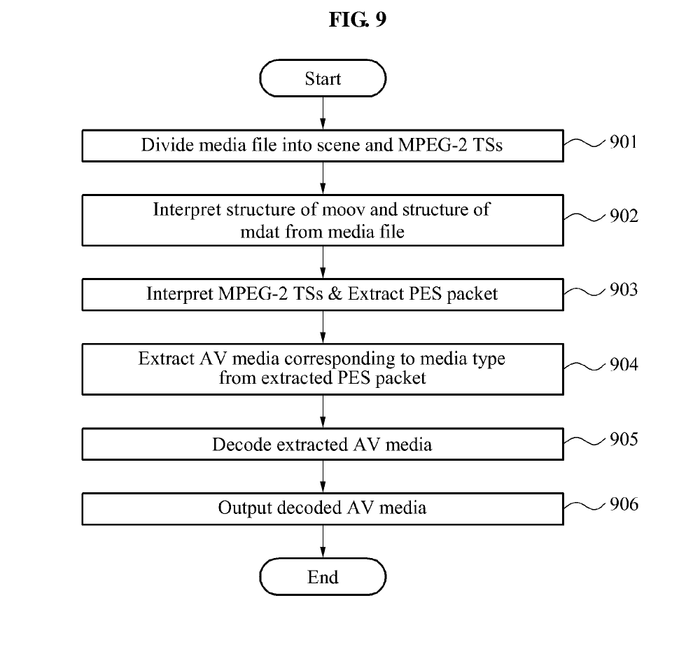

FIG. 9 is a flowchart illustrating a method of playing back content including a media file according to an embodiment of the present invention.

Referring to FIG. 9, in operation 901, a media file may be divided into a scene and a plurality of MPEG-2 TSs. Here, when a scene is contained in the media file, a scene structure, a user event, and a rendering time may be interpreted from the scene, and objects may be rendered based on at least one of the interpreted scene structure, the interpreted user event, and the interpreted rendering time. When a scene descriptor exists in the MPEG-2 TSs, the scene descriptor for rendering a sub-scene may be interpreted.

In operation 902, a structure of a “moov” and a structure of an “mdat” may be interpreted from the media file, and the media file may be decoded. Here, the moov may include media information including at least one of decoding information of AV media, random time access information, and synchronization information between different media, and structure information used to control the plurality of MPEG-2 TSs.

The mdat may include actual contents rendered at a corresponding time based on the scene into which the media file is divided.

In operation 903, the plurality of MPEG-2 TSs may be interpreted, and a PES packet may be extracted.

In operation 904, AV media corresponding to a media type may be extracted from the extracted PES packet.

In operation 905, the extracted AV media may be decoded.

In operation 906, the decoded AV media may be output. Specifically, the decoded AV media may be synchronized based on each rendering time or a user event manipulation, and the synchronized AV media may be output.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of program instructions include both machine code, such as produced by a compiler, and files containing higher level code that may be executed by the computer using an interpreter.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus for writing content, the apparatus comprising:
a media input unit to receive an input of a plurality of Moving Picture Experts Group (MPEG)-2 Transport Streams (TSs);
a scene writing unit to form a scene using a scene descriptor, the scene being associated with the plurality of MPEG-2 TSs; and
a file encoder to encode the plurality of MPEG-2 TSs and the formed scene into a single media file, the single media file comprising a Movie Box (moov) comprising structure information, and a Movie Data Box (mdat) comprising actual contents rendered at a corresponding time based on the formed scene.

2. The apparatus of claim 1, wherein the mdat comprises a main scene descriptor to store the formed scene as structure information used to control the plurality of MPEG-2 TSs.

3. The apparatus of claim 1, wherein the moov comprises:
a scene descriptor track and an Object Descriptor (OD) track to determine whether the plurality of MPEG-2 TSs are connected to each other in the media file, the scene descriptor track and the OD track being a part of the formed scene; and
an Initial Object Descriptor (IOD) to acquire an Elementary Stream Identifier (ES_ID) of the scene descriptor track, and an ES_ID of the OD track.

4. The apparatus of claim 1, wherein the scene writing unit forms the scene comprising a scene structure and a user event that are associated with the plurality of MPEG-2 TSs.

5. The apparatus of claim 1, further comprising:
an MPEG-2 TS interpreter to interpret the plurality of MPEG-2 TSs, and to extract the scene descriptor,
wherein the scene writing unit forms the scene using a scheme of forming multiple scenes by the extracted scene descriptor.

6. An apparatus for playing back content, the apparatus comprising:
a file interpreter to load a media file from a storage device, to divide the loaded media file into a scene and a plurality of MPEG-2 TSs, and to interpret a structure of a moov and a structure of a mdat from the media file, the moov comprising media information comprising at least one of decoding information of Audio/Video (AV) media, random time access information, and synchronization information between different media, and structure information used to control the plurality of MPEG-2 TSs, and the mdat comprising actual contents rendered at a corresponding time based on the scene;
an MPEG-2 TS interpreter to interpret the plurality of MPEG-2 TSs and to extract a Packetized Elementary Stream (PES) packet;
a PES packet interpreter to extract AV media corresponding to a media type from the extracted PES packet;
an AV decoder to decode the extracted AV media; and
an AV output unit to output the decoded AV media.

7. The apparatus of claim 6, further comprising:
a scene interpreter to interpret a scene structure, a user event, and a rendering time from a scene, the scene being received from the file interpreter; and
a scene renderer to render objects based on at least one of the interpreted scene structure, the interpreted user event, and the interpreted rendering time, wherein the filter interpreter transfers the scene to the scene interpreter when the media file contains the scene.

8. The apparatus of claim 7, wherein the scene interpreter interprets a scene descriptor for rendering a sub-scene when the scene descriptor exists in the MPEG-2 TSs.

9. A method of writing content, the method comprising:
receiving an input of a plurality of MPEG-2 TSs;
forming a scene using a scene descriptor, the scene being associated with the plurality of MPEG-2 TSs; and
encoding the plurality of MPEG-2 TSs and the formed scene into a single media file, the single media file comprising a moov comprising structure information, and an mdat comprising actual contents rendered at a corresponding time based on the formed scene.

10. The method of claim 9, wherein the encoding comprises encoding the media file to an mdat, the mdat comprising a main scene descriptor to store the formed scene as structure information used to control the plurality of MPEG-2 TSs.

11. The method of claim 9, wherein the encoding comprises encoding the media file to a moov, the moov comprising a scene descriptor track, an OD track, and an IOD, the scene descriptor track and the OD track being a part of the formed scene and being used to determine whether the plurality of MPEG-2 TSs are connected to each other in a media file being in an International Standards Organization (ISO) file format, and the IOD being used to acquire an ES_ID of the scene descriptor track, and an ES_ID of the OD track.

12. The method of claim 9, wherein the forming comprises forming the scene comprising a scene structure and a user event that are associated with the plurality of MPEG-2 TSs.

13. The method of claim 9, wherein the forming comprises:
interpreting the plurality of MPEG-2 TSs and extracting the scene descriptor; and
forming the scene using a scheme of forming multiple scenes by the extracted scene descriptor.

14. A method of playing back content, the method comprising:
dividing a loaded media file into a scene and a plurality of MPEG-2 TSs;
interpreting a structure of a moov and a structure of an mdat from the media file, the moov comprising media information comprising at least one of decoding information of AV media, random time access information, and synchronization information between different media, and structure information used to control the plurality of MPEG-2 TSs, and the mdat comprising actual contents rendered at a corresponding time based on the scene;
interpreting the plurality of MPEG-2 TSs and extracting a PES packet;
extracting AV media corresponding to a media type from the extracted PES packet;
decoding the extracted AV media; and
outputting the decoded AV media.

15. The method of claim 14, further comprising:
interpreting a scene structure, a user event, and a rendering time from a scene, when the media file contains the scene; and
rendering objects based on at least one of the interpreted scene structure, the interpreted user event, and the interpreted rendering time.

16. The method of claim 14, further comprising:
interpreting a scene descriptor for rendering a sub-scene when the scene descriptor exists in the MPEG-2 TSs.
